(19) United States
(12) Patent Application Publication
(10) Pub. No.: US 2023/0350696 A1
(43) Pub. Date: Nov. 2, 2023

(54) Real Time Workload-Based System Adjustment

(71) Applicant: Advanced Micro Devices, Inc., Santa Clara, CA (US)

(72) Inventors: Anil Harwani, Austin, TX (US); William Robert Alverson, Del Valle, TX (US); Amitabh Mehra, Fort Collins, CO (US); Jerry Anton Ahrens, Sister Bay, WI (US); Grant Evan Ley, Eden, UT (US); Joshua Taylor Knight, Georgetown, TX (US)

(73) Assignee: Advanced Micro Devices, Inc., Santa Clara, CA (US)

(21) Appl. No.: 17/732,741

(22) Filed: Apr. 29, 2022

(51) Int. Cl. G06F 9/445

(52) U.S. Cl. CPC G06F 9/44505

(57) ABSTRACT

Real time workload-based system adjustment is described. In accordance with the described techniques, a processor and a memory are operated according to first settings associated with a first workload. A second workload configured to utilize the processor and the memory is detected. The second workload is associated with second settings. Responsive to detecting the second workload, operation of the processor and the memory are adjusted to operate according to the second settings without rebooting.

### BACKGROUND

Various components of a computing device are operated according to settings, some of which are adjustable to values that exceed thresholds of operation certified by a manufacturer. Adjusting such settings so that components exceed their certified thresholds is known as “overclocking”. By way of example, a processor consumes very little power while in the idle state, but power consumption increases rapidly when the processor is required to perform an action. Some operations require more power than others, and in cases where higher performance is demanded from a processor, clock rates of the processor can be increased such that the processor is run at a frequency higher than specified. When run at the frequency higher than specified, the processor is overclocked. In another example, a memory can be overclocked by modifying specific parameters of the memory in order to achieve faster operating speeds which improves the performance of a computing device.

### BRIEF DESCRIPTION OF THE DRAWINGS

The detailed description is described with reference to the accompanying figures.

FIG. 1 is a block diagram of a non-limiting example system having a processor, a memory, and a controller operable to implement automatic workload based system adjustment without rebooting.

FIG. 2 depicts a non-limiting example of a user interface in one or more implementations.

FIG. 3 depicts a non-limiting example of another user interface in one or more implementations.

FIG. 4 depicts a non-limiting example of another user interface in one or more implementations.

FIG. 5 depicts a procedure in an example implementation of adjusting operation of a processor and a memory without rebooting.

### DETAILED DESCRIPTION

Overview

Conventional systems for overclocking components of a computing device require a reboot of the system once settings for those components are adjusted in order to operate according to the adjusted settings in an overclocking mode. Moreover, conventional systems do not automatically adjust the processor and/or the memory for different workloads in real time.

To solve these problems, the described techniques enable adjustment of system components in real time and without rebooting on a workload-by-workload basis. Moreover, the system adjusts operation of the components for workloads automatically, including by adjusting a processor and/or a memory to operate in overclocking modes. Responsive to detection of a particular workload, for instance, the system automatically adjusts operation of multiple different components (e.g., both the processor and the memory) according to predetermined settings which are associated with the workload. Such predetermined settings, for example, may cause one or more cores of a processor to be activated or deactivated while also configuring the memory to operate in an overclocking mode. As another example, such predetermined settings may configure the processor to operate in an overclocking mode while also adjusting the memory to operate in an overclocking mode, e.g., according to an overclocking memory profile designed for low latency or high bandwidth. Notably, the system adjusts the multiple different components to operate according to the predetermined settings of the particular workload “on the fly”, e.g., in real time and without rebooting.

The ability to dynamically adjust operation of multiple different system components for various workloads without rebooting the system reduces the disruption to computing activity while also improving the end user experience as compared to conventional systems. Moreover, adjusting operation of system components “on the fly” for different workloads optimizes the performance of the system to handle current system activity, e.g., since the workloads are processed using components which operate at settings specified for those workloads. In accordance with the described techniques, example adjustments which are made to system components on a workload-by-workload basis on the fly include, but are not limited to, adjustments to operate a processor and/or a memory in an overclocking mode, adjustments to thresholds of voltage droop at a processor and responses to those voltage droops, adjustments to core configurations of a multi-core processor (e.g., a number of active cores and/or a brand string of the processor), and clock and power inputs to a memory and/or a processor, to name just a few.

In some aspects, the techniques described herein relate to a method including: operating a processor and a memory according to first settings associated with a first workload; detecting a second workload configured to utilize the processor and the memory, the second workload associated with second settings; and responsive to the detecting, adjusting operation of the processor and the memory to operate according to the second settings without rebooting.

In some aspects, the techniques described herein relate to a method, further including performing the second workload by utilizing the processor or the memory with the adjusted operation.

In some aspects, the techniques described herein relate to a method, wherein the adjusting operation of the processor and the memory includes activating or deactivating one or more cores of the processor without rebooting.

In some aspects, the techniques described herein relate to a method, further including informing an operating system of a number of active cores of the processor.

In some aspects, the techniques described herein relate to a method, wherein the adjusting operation of the processor and the memory includes adjusting operation of the memory according to an overclocking memory profile without rebooting.

In some aspects, the techniques described herein relate to a method, wherein the overclocking memory profile includes a high bandwidth overclocking memory profile.

In some aspects, the techniques described herein relate to a method, wherein the overclocking memory profile includes a low latency overclocking memory profile.

In some aspects, the techniques described herein relate to a method, wherein the adjusting operation of the processor and the memory includes adjusting a clock rate of the processor.

In some aspects, the techniques described herein relate to a method, wherein the adjusting operation of the processor and the memory includes deactivating one or more cores of the processor and operating the memory according to an overclocking memory profile without rebooting.

In some aspects, the techniques described herein relate to a method, wherein the adjusting operation of the processor and the memory includes adjusting a clock rate of the processor and operating the memory according to an overclocking memory profile without rebooting.

In some aspects, the techniques described herein relate to a system including: a memory; a processor having multiple cores; and a controller configured to adjust operation of the memory and the processor according to different settings without rebooting.

In some aspects, the techniques described herein relate to a system, wherein the controller is configured to adjust operation of the memory and the processor responsive to a workload.

In some aspects, the techniques described herein relate to a system, wherein the controller is configured to adjust operation of the memory and the processor responsive to input from an application.

In some aspects, the techniques described herein relate to a system, wherein the controller is configured to adjust operation of the memory and the processor responsive to user input from a user.

In some aspects, the techniques described herein relate to a system, further including a table for storing the different settings, the table accessible by the controller.

In some aspects, the techniques described herein relate to a system, wherein the controller is configured to adjust operation of the memory and the processor by activating or deactivating one or more cores of the processor without rebooting.

In some aspects, the techniques described herein relate to a system, wherein the controller is configured to adjust operation of the memory and the processor by adjusting operation of the memory according to an overclocking memory profile without rebooting.

In some aspects, the techniques described herein relate to a method including: receiving input to adjust settings for operating a processor and a memory in an overclocking mode, wherein the settings adjusted by the input include at least two of a voltage droop threshold and corresponding response of the processor, a core configuration of the processor, or a clock and power input to the memory; and responsive to the input, switching operation of the processor or the memory to operate in the overclocking mode without rebooting.

In some aspects, the techniques described herein relate to a method, wherein the input includes user input received via a user interface.

In some aspects, the techniques described herein relate to a method, wherein the input is received from an application processed by the at least one of the memory or the processor.

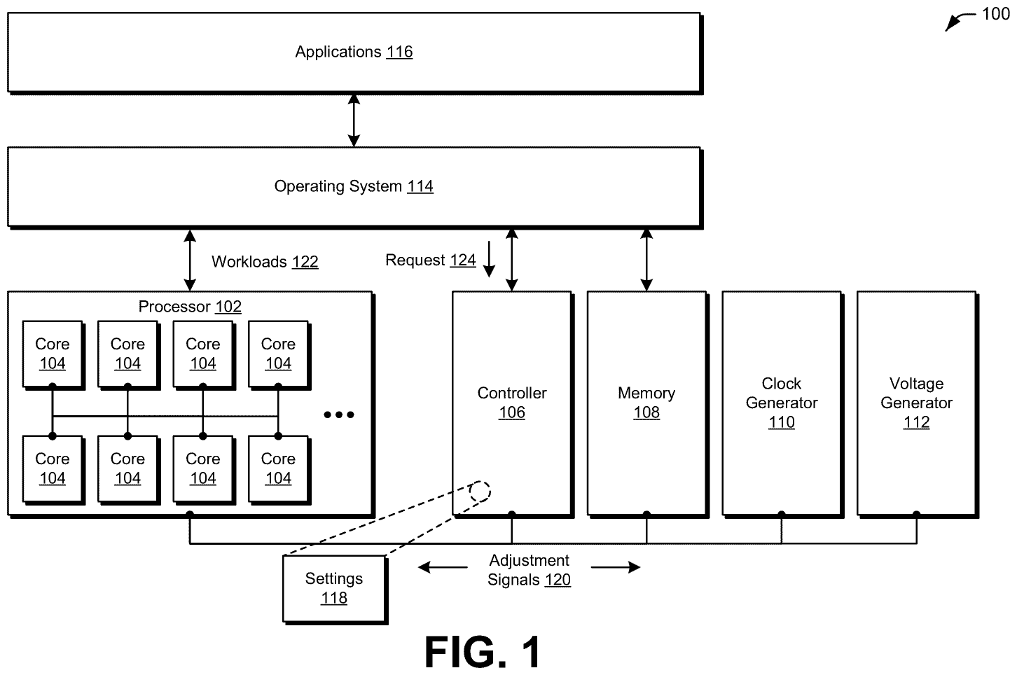

FIG. 1 is a block diagram of a non-limiting example system 100 having a processor, a memory, and a controller operable to implement automatic workload based system adjustment without rebooting. In particular, the system 100 includes a processor 102, which is depicted having multiple cores 104. Processors having multiple cores (e.g., two or more separate processing units) on a single integrated circuit are commonly referred to as “multi-core processors.” Although depicted with multiple cores in the illustrated example, in one or more implementations, the processor 102 only has a single core 104. The system 100 also includes a controller 106, a memory 108, a clock generator 110, and a voltage generator 112. The processor 102, the controller 106, and the memory 108 are operable to implement an operating system 114 and one or more applications 116.

In accordance with the described techniques, the processor 102, the controller 106, the memory 108, the clock generator 110, and the voltage generator 112 are coupled to one another via one or more wired or wireless connections. Example wired connections include, but are not limited to, traces and system buses connecting two or more of the processor 102, the controller 106, the memory 108, the clock generator 110, and the voltage generator 112. Examples of devices in which the system 100 is implemented include, but are not limited to, servers, personal computers, laptops, desktops, game consoles, set top boxes, tablets, smartphones, mobile devices, virtual and/or augmented reality devices, wearables, medical devices, systems on chips, and other computing devices or systems.

The memory 108 is a device or system that is used to store information, such as for immediate use in a device, e.g., by the processor 102. In one or more implementations, the memory 108 corresponds to semiconductor memory where data is stored within memory cells on one or more integrated circuits. In at least one example, the memory 108 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 108 corresponds to or includes non-volatile memory, examples of which include flash memory, read-only memory (ROM), programmable read-only memory (PROM), erasable programmable read-only memory (EPROM), and electronically erasable programmable read-only memory (EEPROM). The memory 108 is configurable in a variety of ways that support automatic adjustment in real time and without rebooting based on workloads in accordance with the described techniques.

In one or more implementations, the memory 108 is configured as a dual in-line memory module (DIMM). A DIMM includes a series of dynamic random-access memory integrated circuits, and the modules are mounted on a printed circuit board. Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the memory 108 is configured as a small outline DIMM (SO-DIMM) according to one of the above-mentioned SDRAM standards, e.g., DDR, DDR2, DDR3, DDR4, and DDR5. It is to be appreciated that the memory 108 is configurable in a variety of ways without departing from the spirit or scope of the described techniques.

In accordance with the described techniques, the controller 106 is configured to adjust operation of the processor 102 and the memory 108 so that they operate according to different settings. In particular, the controller 106 adjusts the operation of the processor 102 and the memory 108 according to different settings in real time and without rebooting, e.g., “on the fly.” In one or more implementations, the controller 106 further adjusts the operation of the processor 102 and the memory 108 based on a workload and/or responsive to input, e.g., from a user, an application 116, and/or an algorithm.

By way of example, the controller 106 adjusts operation of the processor 102 and/or the memory 108 in real time and without rebooting so that they operate according to different settings specified for one or more of processor overclocking, voltage droop detection and response, memory overclocking, and processor core configuration (e.g., a number of active cores). Since the controller 106 is capable of adjusting operation of system components on a per workload basis, processor overclocking, voltage droop detection and response, memory overclocking, and/or processor core configuration are customizable on a per workload basis (or customizable for groups of workloads). In at least one example, therefore, a particular workload is associated with specified settings for at least one of voltage droop detection and response, memory overclocking, and processor core configuration. In this example, when the controller 106 detects that the particular workload is to be processed (or is being processed) by the system 100, the controller 106 adjusts operation of the processor 102 and the memory 108 “on the fly” to operate according to the particular workload's settings. This includes adjusting the processor 102 and/or the memory 108 on the fly to operate according to one or more overclocking settings for the processor 102 and/or the memory 108 associated with the workload.

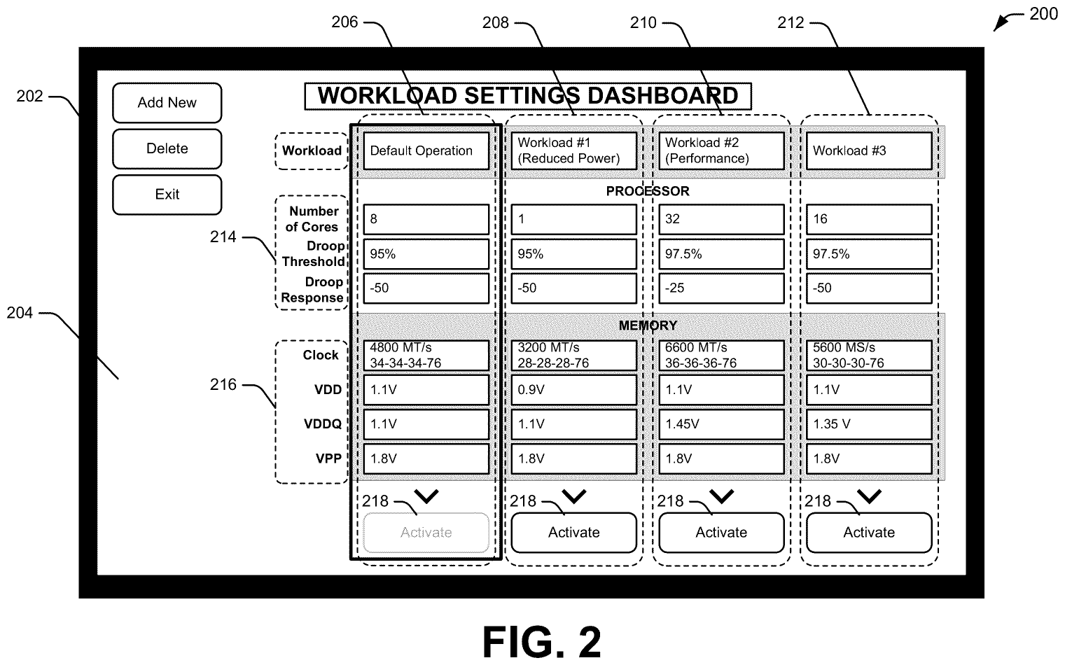

In at least one implementation, the controller 106 includes, or otherwise has access to, settings 118. Alternatively or in addition, the settings 118 are maintained in a different location, such as the memory 108 or a data store (not shown). The settings 118 specify how to operate the processor 102 and the memory 108 based on one or more conditions, such as based on a detected temperature of the system 100 (or components of the system 100), a desired power consumption of the system 100, and/or a workload processed by the system 100. Alternatively or in addition, the settings 118 are specified via user input, as depicted in more detail in relation to FIGS. 2-4.

In one or more implementations, the settings 118 are configured as a table that is accessible to the controller 106. It is to be appreciated that in variations the settings 118 are configured in different ways without departing from the spirit or scope of the described techniques. Regardless of particular format, the settings 118 map one or more conditions to one or more settings of the system 100. For instance, the settings 118 map a particular condition (e.g., temperature) to settings for one or more of processor overclocking, voltage droop detection and response, memory overclocking, and processor core configuration. Thus, when the particular condition (e.g., temperature) is detected, the controller 106 references the settings 118 to identify which settings to adjust the processor 102 and the memory 108 to for operation. The controller 106 then adjusts the processor 102 and the memory 108 to operate according to those settings for the condition in real time and without rebooting, e.g., “on the fly.”

In another example, a condition corresponds to a particular workload, such that the settings 118 map the particular workload to settings for one or more of processor overclocking, voltage droop detection and response, memory overclocking, and processor core configuration. Thus, when the particular workload is detected, the controller 106 references the settings 118 to identify which settings to adjust the processor 102 and the memory 108 to for operation. The controller 106 then adjusts the processor 102 and the memory 108 to operate according to those settings for the workload in real time and without rebooting, e.g., “on the fly.” It is to be appreciated that in implementations, the settings 118 map detectable conditions (e.g., environmental conditions and/or workloads) to settings for more, fewer, or different operational aspects from processor overclocking, voltage droop detection and response, memory overclocking, and processor core configuration, such as different processor overclocking aspects, without departing from the spirit or scope of the described techniques.

In the context of voltage droop detection and response, in one or more implementations, the settings 118 include one or more voltage droop thresholds and droop responses which are associated with an overclocking mode of the processor 102. In variations, the settings 118 associate such settings with, for example, a temperature range and/or a workload. In accordance with the described techniques, a voltage droop threshold specifies an amount of voltage droop in an output voltage from the voltage generator 112, which, once satisfied, causes the controller 106 to initiate a response of the system 100 to the voltage droop by performing one or more actions, e.g., by momentarily decreasing the clock rate to account for the voltage droop.

A voltage droop threshold is definable in different ways in various implementations. In one or more implementations, for example, the voltage droop threshold is defined as a percentage of an analog voltage supply value (e.g., a processor overclocking parameter from the controller 106), such that when the output voltage as a percentage of the analog voltage supply value satisfies (e.g., is less than or equal to) the voltage droop threshold, the controller 106 initiates a corresponding response defined by the settings 118. Alternatively or in addition, a voltage droop threshold is defined as a fixed offset from the analog voltage supply value, such that when an amount the output voltage is offset from the analog voltage supply value satisfies (e.g., is greater than or equal to) the voltage droop threshold, the controller 106 initiates a corresponding response. Alternatively or in addition, a voltage droop threshold is a fixed voltage level, such that when the output voltage corresponds to a voltage level that satisfies (e.g., is less than or equal to) the threshold, the controller 106 initiates a corresponding response. In variations, a voltage droop threshold is definable in other ways.

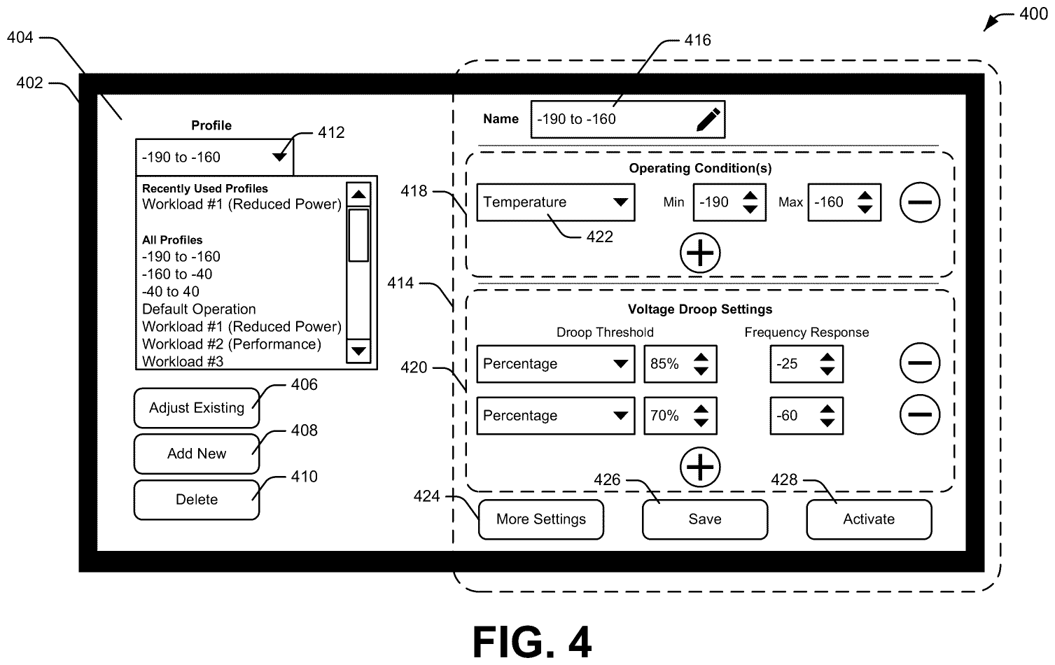

A droop response defines a response of the controller 106 to detection that a respective voltage droop threshold is satisfied by an output voltage of the voltage generator 112. Based on detection that a voltage droop threshold is satisfied, for example, the controller 106 performs one or more actions to compensate for the voltage droop. For example, in response to detecting the voltage droop, the controller sends adjustment signals 120 to the voltage generator 112 to set the analog voltage supply and/or the input voltage, and sends overclock parameters indicative of those changes to the clock generator 110. In one or more implementations, a droop response includes a frequency adjustment that specifies an amount that a clock rate is to be decreased to mitigate the voltage droop defined by the respective voltage droop threshold in the settings 118, e.g., by stretching a reference clock signal. In one or more implementations, such a droop response includes instructions to implement clock stretch (e.g., stretching the reference clock signal) to reduce the impact of the voltage droop. By way of example, a user interface exposed to the user enables the user to configure a voltage droop threshold to 2.5% of the output voltage, and a droop response to a frequency adjustment of 25 megahertz. Subsequently, when the output voltage decreases by 2.5% (thus satisfying the user configured voltage droop threshold), the clock rate of the processor 102 is temporarily stretched by decreasing the clock rate by 25 megahertz to account for the voltage droop. An example of a user interface for viewing and/or specifying voltage droop detection and response settings is discussed in more detail in relation to FIG. 4.

In addition to implementing overclocking for the processor 102 in real time and without rebooting (e.g., through voltage droop detection and response), the system 100 (e.g., the controller 106) is also configured to implement overclocking for the memory 108 in real time and without rebooting. For instance, the controller 106 manages communication of data to and from the memory 108. By way of example, the controller 106 manages the communication of data to the memory 108 from the processor 102 and the communication of data from the memory 108 to the processor 102, e.g., over a coupling between the memory 108 and the processor 102. Additionally, the controller 106 trains the memory 108 (e.g., during a boot process) to operate according to the settings 118 (e.g., clock and/or power settings), which are configurable to include one or more memory profiles, e.g., for respective conditions and/or workloads. Examples of memory profiles include high bandwidth and low latency memory profiles.

Broadly, the processor 102 requests access to data from the memory 108 for performing one or more operations in relation to such data, e.g., in connection with executing an application 116 and/or tasks of the operating system 114. The illustrated example includes workloads 122, which are indicative of the processing performed by the processor 102, e.g., using one or more of the cores 104.

In accordance with the described techniques, in one or more implementations, the settings 118 include one or more non-overclocking memory profiles (not shown) and one or more overclocking memory profiles (not shown). Based on such profiles, the controller 106 and/or another component of the system 100 (e.g., physical layer (PHY)) are configured to train the memory 108. For instance, the controller 106 and/or the other component of the system 100 (e.g., the physical layer) train the memory 108 prior to a request to switch in real time from one memory profile to another memory profile without rebooting, e.g., “on the fly.” In at least one variation, for example, the controller 106 trains the memory 108 with overclocking memory profiles specified in the settings 118 during a boot up process of the system 100. In one or more implementations, the controller 106 also trains the memory 108 with non-overclocking memory profiles specified in the settings 118 along with training the overclocking memory profiles. For example, both the overclocking memory profiles and the non-overclocking memory profiles are trained during the boot up process of the system 100. Alternatively or in addition, the controller 106 is configured to train the memory 108 with one or more memory profiles during a different phase, such as while the system is in a “sleeping” state.

In one or more implementations, the controller 106 trains the memory 108 with a profile by testing whether the memory 108 is capable of operating using a portion of the settings 118 that corresponds to the profile. By way of example, and not limitation, the controller 106 trains the memory 108, at least in part, by running one or more algorithms for enabling data to be reliably written to and/or read from at least a portion of the memory 108 using the settings of the profile. Examples of such algorithms include, but are not limited to a write leveling algorithm, a multi-purpose register (MPR) pattern write algorithm, a read centering algorithm, and/or a write centering algorithm. It is to be appreciated that training the memory 108 with settings that correspond to a memory profile includes more and/or different operations without departing from the spirit or scope of the described techniques.

If, based on the training, the controller 106 detects that it is capable of operating the memory 108 using the settings specified by a particular profile (i.e., the profile “passes” the training), then the controller 106 causes the particular profile to be available for operation of the system 100. By way of example, the controller 106 causes the memory 108 to operate using the settings of the particular profile (e.g., a default memory profile), or the controller 106 enables subsequent real time switching to the profile without rebooting, e.g., “on the fly.”

As described herein, switching from one memory profile to another memory profile “on the fly” refers to adjusting the settings according to which the memory 108 operates in real time, so that the memory 108 subsequently operates with settings that are different (e.g., settings of a requested memory profile) without rebooting the memory 108 and/or the system 100. In other words, the memory 108 and/or the system 100 are not rebooted over a time period that spans over a first time when the memory 108 operates according to a first memory profile, a second time when the controller 106 causes the memory 108 to switch to a second memory profile for operation, and a third time when the memory 108 operates according to the second memory profile. Training the memory 108 with multiple memory profiles during boot up, and also switching in real time from one memory profile to another memory profile in real time and without rebooting, contrasts with conventional techniques which switch from one memory profile to another by rebooting the system and by training the conventional system with only the other memory profile during the boot up, e.g., so that the conventional system can operate using the other memory profile. In other words, in a conventional system, a request to switch memory profiles is received, and the system reboots before the requested memory profile is used. In contrast, the techniques described herein receive a request 124 to switch memory profiles, and responsive to this request 124 dynamically switch to the requested memory profile without rebooting the system.

By way of contrast to the discussion above about “passing” the training, if, based on the training, the controller 106 detects that it is not capable of operating the memory 108 using the settings of a particular profile, then the controller 106 reports that the profile has failed the training, e.g., the controller 106 generates and/or communicates a notification indicating that the profile failed the training. In one or more implementations, the controller 106 also prevents the memory 108 from operating using a memory profile that fails the training.

As noted above, a memory profile in the settings 118 specifies one or more memory settings according to which the memory 108 operates. In accordance with the described techniques, a non-overclocking memory profile specifies settings for the memory 108 that do not exceed certified settings, e.g., a clock rate specified in a non-overclocking memory profile does not exceed the clock rate certified by a manufacturer of the memory 108. In contrast, an overclocking memory profile specifies at least one setting for the memory 108 that exceeds a certified setting, e.g., a clock rate specified in an overclocking memory profile exceeds the clock rate certified by a manufacturer of the memory 108. Broadly, an overclocking memory profile enables the memory 108 to operate in an overclocking mode.

Memory profiles (e.g., the non-overclocking memory profiles and the overclocking memory profiles) in the settings 118 are configured to specify a variety of settings for operating the memory 108 in one or more implementations, such as various clock and power settings. Example settings include, but are not limited to, a data rate (e.g., megatransfers per second), a number of cycles between sending a column address to memory and the beginning of data in a response (e.g., CAS or tCAS), a minimum number of clock cycles to open a row and access a column (e.g., tRCD), a measure of latency between issuing a precharge command to idle or close open row and an activate command to open a different row (e.g., tRP), a minimum number of clock cycles between a row active command and issuing a precharge command (e.g., tRAS), nominal power supply voltage (e.g., VDD), output stage drain power voltage (e.g., VDDQ), and programming power voltage (e.g., VPP). It is to be appreciated that one or more non-overclocking memory profiles and overclocking memory profiles specify values for one or more of those settings and/or various other settings associated with operating memory without departing from the spirit or scope of the described techniques.

In accordance with the described techniques, the controller 106 and/or another component of the system 100 are configured to set clock and power inputs to the memory 108 to cause the memory 108 to operate according to a memory profile, e.g., a non-overclocking memory profile or an overclocking memory profile. Additionally, the controller 106 and/or the other component are configured to adjust those clock and power inputs to cause the memory 108 to switch in real time from operating according to a first memory profile to operating according to a second memory profile and, notably, without rebooting the memory 108 or the system 100. The controller 106 is able to adjust these inputs to operate according to a different memory profile because the memory 108 has been pretrained with the different memory profile, e.g., during the boot process.

For example, the controller 106 switches to a different memory profile specified in the settings 118 by sending one or more adjustment signals 120 to the voltage generator 112 to adjust a supply voltage (e.g., VDD), such that the clock and power inputs to the memory 108 subsequently include the supply voltage as adjusted according to the adjustment signals 120. Additionally or alternatively, the controller 106 sends an adjustment signal 120 to the clock generator 110 to change a frequency of a clock rate, such that clock and power inputs to the memory 108 subsequently include a reference clock signal as adjusted according to the adjustment signals 120. The controller 106 is operable to adjust clock and power inputs to the memory 108 in various ways to produce the settings specified in a given memory profile of the settings 118 for operating the memory 108.

In one or more implementations, the controller 106 causes a switch in real time from a first memory profile to a second memory profile in real time and without rebooting based on a request 124. In one example, the request 124 requests to switch to the second memory profile, such as based on or responsive to user input, based on or responsive to an instruction from an application 116, or based on or responsive to an algorithm that monitors workload parameters. For instance, user input is received (e.g., via a user interaction or selection with a displayed control of a user interface) to activate the second memory profile. In an example where the request 124 is application based, an application 116 requests that the memory 108 activate the second memory profile for execution of the application 116. In an example where the request 124 is algorithm based, an algorithm (not shown) provides the request 124 based on workload parameters, e.g., of one or more of the workloads 122.

In accordance with the described techniques, for instance, different memory profiles in the settings 118 specify settings for different workloads (or for groups of workloads), such that switching in real time from one memory profile of the settings 118 to a different memory profile of the settings 118 without rebooting occurs based on detection of the workloads. In addition to switching operation of the memory 108 on the fly for overclocking, the system 100 (e.g., the controller 106) is also configured to adjust a core configuration (e.g., a number of active cores 104 or branding configuration) of the processor 102 in real time and without rebooting.

In accordance with the described techniques, for example, the controller 106 is configured to selectively activate and deactivate the cores 104 of the processor 102 without rebooting the system 100. For instance, the controller 106 is configured to signal the processor 102 to activate or deactivate the cores 104 on an individual basis without rebooting the system 100. Alternatively or in addition, the controller 106 is configured to signal the processor 102 to activate or deactivate multiple cores 104 at a time without rebooting the system 100. In one or more implementations, the controller 106 communicates the adjustment signals 120 to the processor 102 for power gating and/or clock gating the cores 104 that are to be deactivated.

Adjusting which cores of a multi-core processor are active “on the fly” (e.g., without rebooting) contrasts with conventional techniques. For instance, conventional approaches involve rebooting the system. During this reboot, an adjusted number or selection of cores is activated. Further, the operating system is informed about the number or selection of active cores as part of the reboot. In accordance with the described techniques, though, the controller 106 adjusts the number or selection of active cores 104 without rebooting and does so in an operating-system “aware” way.

In an example involving a core configuration adjustment, the request 124 from the operating system 114 corresponds to a request for a different core configuration, e.g., a different number or selection of active cores. How many cores 104 and/or which cores 104 to activate or deactivate is indicated in or determinable from the request 124. In one or more implementations, the controller 106 is also configured to inform the operating system 114 of the number of active cores. For instance, the controller 106 informs the operating system 114 and the applications 116 of the current core count, e.g., the number of cores 104 that are active. In one or more implementations, the controller 106 provides, to the operating system 114 and/or the applications 116, a brand string which identifies a branding configuration of the processor 102. In this way, the controller 106 informs the operating system 114 and the applications 116 about the branding configuration of the processor 102. By way of example, the controller 106 informs one or more of the operating system 114 and the applications 116 about a core configuration in connection with switching from one core configuration to another. Through such communications the operating system 114 is thus made “aware” of adjustments carried out by the controller 106, which it carries out by power gating and/or clock gating one or more of the cores 104.

In one or more implementations, in order to inform the operating system 114 about which cores 104 are activated (or deactivated) due to an adjustment, the controller 106 formats communications to the operating system 114 according to a specification associated with power configuration. In one or more implementations, the controller 106 formats those communications according to the Advanced Configuration and Power Interface (ACPI) specification. In at least one such implementation, the controller 106 is configured to indicate (e.g., falsely) to the operating system 114 via a communication that selective cores 104 (e.g., which are requested to be deactivated) are too hot (e.g., hotter than a threshold) or are not available, even though a physical temperature of those cores 104 does not actually exceed the threshold. When the operating system 114 is notified that a core 104 is too hot, the operating system 114 is configured to programmatically take the core 104 “offline” so that it is not available for use. Due to this, a scheduler (not shown) of the operating system 114 avoids scheduling threads, processes, and/or data flows (e.g., workloads 122) using the cores 104 that have been taken offline.

In at least one example implementation, the operating system 114 and/or one or more of its components, are configured to monitor thermal zones (e.g., of the processor 102) and, based on the monitoring, they are further configured to instruct the controller 106 (e.g., via the request 124) to control conditions (e.g., power consumption and cooling-fan speed) under which hardware components in those thermal zones operate. In this example, the operating system 114 and/or those one or more components are not configured to monitor the cores 104, per se, or to instruct the controller 106, specifically, to activate or deactivate particular cores 104. This can be the case where the communications between the operating system 114 and the controller 106 are governed by a specification, such as the ACPI specification. At least one version of the ACPI specification specifies communication protocols for controlling operating conditions of hardware components on a thermal-zone by thermal-zone basis—rather than on a core-by-core basis. In at least one such implementation, the described techniques therefore exploit these communication protocols to activate and deactivate the cores 104 without rebooting the system and also so that the operating system 114 is aware of the active cores 104.

By way of example, in one or more implementations where communication between the operating system 114 and the controller 106 is governed at least in part by such a specification, the controller 106 includes a table (not shown) that maps thermal zones to the cores 104. For instance, the table maps each core 104 to a respective thermal zone, such that there is a one-to-one mapping between the cores 104 and thermal zones. Accordingly, when the controller 106 receives an indication (via the request 124) that a thermal zone is “too hot,” the controller 106 identifies the respective core 104, based on the mapping between thermal zones and cores 104 in the table, and then deactivates the respective core 104.

In implementations that further involve outputting a user interface and allowing a user to select which cores 104 of the processor 102 to activate or deactivate via the user interface, an application 116 or firmware that corresponds to the user interface also maps selected cores 104 to thermal zones, e.g., by using a table similar to the one included at the controller 106. Based on the mapping, the application 116 or firmware is configured to communicate an indication to the operating system 114 which specifies thermal zones to control. This is so that the operating system 114 receives a type of information that enables it to communicate with the controller 106, e.g., thermal-zone based information rather than core-based information.

Although the example discussed just above exploits a protocol for configuring communications between the operating system 114 and the controller 106 based on thermal zones, in one or more implementations, the communications between the operating system 114 and the controller 106 are configured based on cores. In such implementations, use of a mapping between cores and thermal zones (e.g., maintained in one or more tables) is not necessary. The request 124 and the informing communications are configurable in various ways—that enable the controller 106 to activate and deactivate the cores 104 on a core-by-core basis “on the fly” and that enable the operating system 114 to inform applications 116 how many cores are “online” and also when cores 104 go “offline” without rebooting—without departing from the spirit or scope of the described techniques.

Once informed about an adjusted configuration of active cores 104, the operating system 114 further provides an indication of the active cores 104 to the applications 116 (not shown). Based on the number of active cores 104, a scheduler of the operating system 114 schedules the workloads 122 for processing by the processor 102's cores 104, e.g., on the active cores 104. These workloads 122 correspond to or otherwise include threads, processes, and data flows for implementing the applications 116 and the operating system 114.

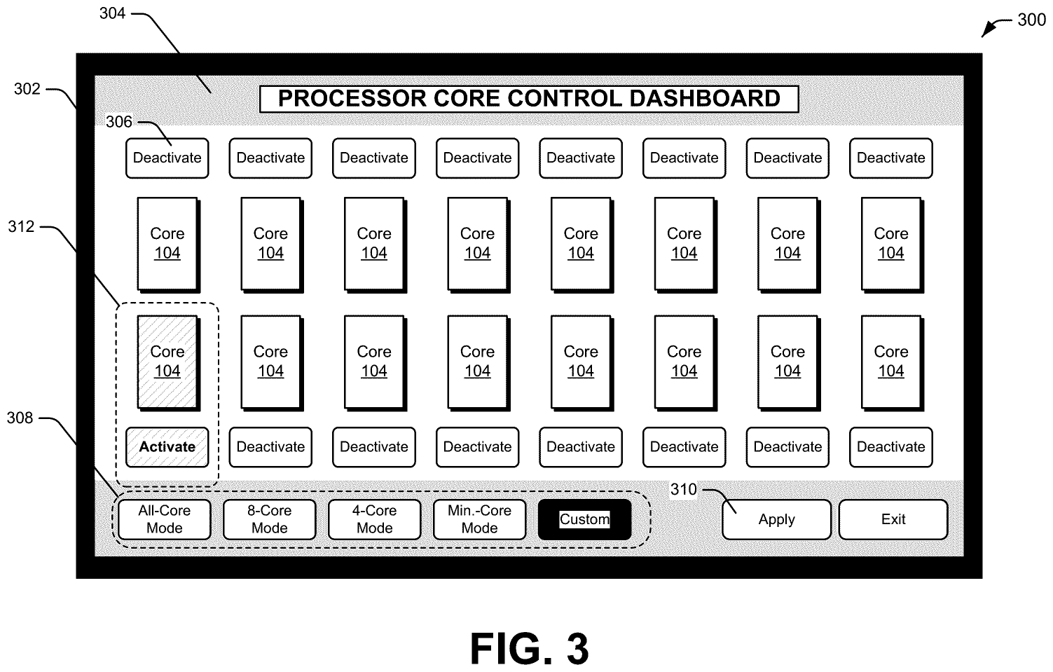

In one or more implementations, the system 100 enables users to provide input for adjusting the active cores 104, such as a number of active cores, which specific cores 104 are activated and deactivated, and/or a branding configuration of the processor 102. An example user interface which enables users to request adjustments to the active cores is discussed in more detail in relation to FIG. 3. In such examples, the request 124 is based on and responsive to user input.

Alternatively or in addition, the system 100 enables one or more of the applications 116 to request adjustments to the active cores, such as a number of active cores and/or which specific cores 104 are activated and deactivated. In such examples, the request 124 is based on and responsive to communication from an application 116. Alternatively or in addition, the operating system 114 (or a process of the operating system 114) is configured to request adjustments to the activated cores for various applications 116. For instance, when a particular application 116 that is associated with a particular core configuration is launched, the system 100 enables the operating system 114, or a process that controls core configurations for various applications, to request an adjustment of the processor 102's core configuration to the particular core configuration associated with the particular application.

Alternatively or in addition, the system 100 adjusts a core configuration of the processor 102 based on the workloads 122. In one example, when a first workload 122 is launched (or detected), the controller 106 and the operating system 114 communicate to cause the processor 102 to operate using a core configuration specified for the first workload 122 in the settings 118. When a second workload 122 associated with a different core configuration specified in the settings 118 is launched (or detected), the controller 106 and the operating system 114 communicate to adjust the processor 102 to operate using the different core configuration associated with the second workload 122. In one or more implementations, different workloads are associated with groups, such that workloads associated with a same group are associated with a same core configuration in the settings 118 and workloads associated with different groups are associated different core configurations in the settings 118.

In one or more implementations, the system 100 adjusts a configuration of active cores 104 based on one or more characteristics of the workloads 122 actively being processed by the processor 102, e.g., licensing fees for using different numbers of cores. When a workload 122 is launched, for instance, the controller 106 adjusts the active cores 104 on the fly (e.g., without rebooting) so that a certain number of the cores 104 are activated. In at least one variation, a “brand string” of the processor 102 is communicated by a component of the system 100 (e.g., the operating system 114) to a particular application 116 corresponding to the workload 122. The brand string is based on the number of cores 104 activated while a workload 122 of the particular application 116 executes. In one or more variations, the brand string communicated when eight cores 104 of the processor 102 are activated is different from the brand strings communicated when one core 104 or sixteen cores 104 are activated. The brand string is thus capable of indicating different branding configurations of processors in connection with different numbers of active cores, even though the processor 102 physically includes a set number of total cores 104.

In the context of a user interface for adjusting various overclocking settings of the system 100 and causing the system 100 to switch to operate using different overclocking settings in real time and without rebooting, consider the following discussion of FIG. 2.

FIG. 2 depicts a non-limiting example 200 of a user interface in one or more implementations. The example 200 includes a display device 202 outputting a workload settings user interface 204, which receives user input for adjusting the settings 118 and associating sets of the settings 118 with one or more operating conditions, e.g., workloads.

Here, the workload settings user interface 204 includes multiple profiles, including a default operation profile 206 and profiles for multiple different workloads 208-212. It is to be appreciated, however, that in variations, profiles of overclocking settings are specified for operating conditions other than for workloads, such as for detected system temperature (or ranges of temperatures), optimizations (e.g., thermal or power reduction, high bandwidth, or low latency), and/or applications.

The profiles 206-212 are also depicted with respective sets of settings, e.g., a portion of the settings 118 that corresponds to the profile. In this example 200, those settings control operation of the processor 102 (e.g., core configuration, voltage droop detection and response) and the memory 108 (e.g., clock and power inputs). In one or more implementations, a set of settings for a default operation profile 206 corresponds to non-overclocking settings whereas the sets of settings for the profiles 208-212 include at least one overclocking setting for the processor 102 or the memory 108. Thus, the settings 118 are configured to maintain both non-overclocking and overclocking settings for various profiles, such that one or more workloads are associated with non-overclocking settings and one or more workloads are associated with at least one overclocking setting. As mentioned above and below, sets of the settings are also received and stored to implement operational characteristics of the system 100 such as high bandwidth and low latency of the components.

In this example 200, the profiles 206-212 are depicted with processor settings 214 and memory settings 216—maintained in the settings 118. The processor settings 214 depicted include core configuration settings (e.g., a number or active cores) and voltage droop settings. The memory settings 216 depicted include clock and power settings. It is to be appreciated that different settings for overclocking the processor 102 and the memory 108 can be stored or otherwise maintained by the settings 118 without departing from the described techniques.

Additionally, the settings 118 are adjustable, including the settings for a respective profile (e.g., a workload). The settings 118 are adjustable, for instance, based on user input, based on specification in a file (e.g., associated with an application or firmware), based on an update, and so on. In various implementations, the settings 118 are adjustable via the user interface 204. In other words, the user interface 204 enables settings 118 to be specified (based on user input) for the processor 102 and the memory 108. This includes specifying settings for operating the processor 102 and/or the memory 108 in an overclocking mode, e.g., where at least one of the settings 118 according to which the processor 102 or the memory 108 operates is an overclocking setting. In this example 200, the user interface 204 includes various graphical user interface controls (e.g., text fields) via which user input is receivable to adjust the processor settings 214 and the memory settings 216, including adjusting those settings for overclocking the processor 102 and the memory 108. Certainly, a user interface that receives input to specify or activate settings for operation of the processor 102 and the memory 108 (including in an overclocking mode) is configurable in different ways without departing from the spirit or scope of the described techniques.

In accordance with the described technique, when a workload is detected by the system 100, the system 100 (e.g., the controller 106) adjusts operation of the processor 102 and/or the memory 108 in real time and without rebooting to operate according to the settings specified for the workload (e.g., in the settings 118). In the context of the example 200, the settings specified for the workload are viewable and/or adjustable via the user interface 204. Settings are also viewable and/or adjustable via the user interface 204 for at least one additional workload. Thus, when an additional workload is subsequently detected by the system 100, the system 100 (e.g., the controller 106) automatically adjusts operation of the processor 102 and/or the memory 108 in real time and without rebooting. During this subsequent adjustment, the system 100 adjusts the processor 102 and/or the memory 108 to operate according to the settings specified for the additional workload (e.g., in the settings 118). In accordance with the described techniques, the settings 118 specified for at least one of the workload or the additional workload include at least one overclocking setting.

In addition to detecting a workload and automatically adjusting operation of the processor 102 and/or the memory 108 in real time and without rebooting according to settings specified for the workload, the system 100 is also configured to adjust operation of the processor 102 and/or the memory 108 in real time and without rebooting according to different settings based on user input. In one example, for instance, user input selecting a graphical activation control 218 is received. Responsive to receipt of such user input, the system 100 adjusts operation of the processor 102 and/or the memory in real time and without rebooting so that those components operate according to settings of the profile (e.g., workload) of the selected graphical activation control 218. In the context of other example user interfaces that can be launched from the user interface 204 and/or that receive user input to change settings 118 for overclocking the processor 102 and/or the memory 108, consider the following discussion of FIGS. 3-4.

FIG. 3 depicts a non-limiting example 300 of another user interface in one or more implementations. The example 300 includes a display device 302 outputting a core control user interface 304, which enables a user to control which of the cores 104 are active and to selectively activate and deactivate the cores 104 without rebooting and in an operating system “aware” manner.

In the illustrated example 300, the core control user interface 304 is depicted displaying representations of multiple cores 104 of the processor 102. In one or more implementations, the representations of the multiple cores 104 are displayed in a manner that is indicative or substantially corresponds to their physical positions on an integrated circuit of the processor 102.

Here, the core control user interface 304 also includes a respective control 306 for each of the cores 104. The control 306 is selectable by a user to request activation or deactivation of the respective core 104. If a core 104 is active, for instance, the respective control 306 is selectable to request that the core 104 be deactivated. If a core 104 is not active (e.g., it has been deactivated), however, the respective control 306 is selectable to request that the core 104 be activated.

In this example 300, the core control user interface 304 also includes mode controls 308, which are selectable to request a particular mode of operation of the processor 102 or are transitioned to (and visually emphasized) based on user selection of one or more of the respective controls 306. In one or more variations, the different modes correspond to different numbers of active cores 104, such as a mode in which all the cores 104 are active and various modes in which different subsets of the cores 104 are active. Although not depicted, in one or more implementations, the core control user interface 304 includes controls that enable a user to select various optimizations of the processor 102, such as to optimize which of the cores are activated to optimize for power consumption, thermal conditions, performance, low latency, and high bandwidth, to name just a few.

In one or more implementations, the system 100 causes the active cores 104 to be adjusted responsive to a selection of a single respective control 306. For instance, responsive to selection of a single respective control 306, the operating system 114 submits a request 124 to the controller 106 indicating to adjust (e.g., activate or deactivate) the respective core 104. In response, the controller 106 adjusts (e.g., activates or deactivates) the respective core 104 according to the request 124 without rebooting. The controller 106 then issues a communication to the operating system 114 to inform it about the adjustment.

Alternatively, the system 100 causes the active cores 104 to be adjusted responsive to selection of a single mode control 308, responsive to selection of one or more of the respective controls 306 and also selection of an apply control 310, and/or responsive to selection of a mode control 308 and also selection of the apply control 310. When a mode control 308 is selected, in one or more implementations, a component of the system 100 (e.g., an application 116, the operating system 114, or the controller 106) determines which of the cores 104 to activate or deactivate in order to adjust the active cores 104 and enable the processor 102 to operate using the requested mode. In one example, for instance, the application 116, the operating system 114, or the controller 106 references a table which indicates a configuration of active cores 104, such that the cores to activate and deactivate is determinable based on a difference between the indicated configuration and currently active cores. Alternatively or in addition, the application 116, the operating system 114, or the controller 106 determines which of the cores to activate or deactivate based, at least in part, on conditions of the cores 104, such as whether a core 104 is currently operating, whether a core 104 was operating during a previous time interval, a temperature of a core 104, an amount of time a core 104 has been operating, and so forth.

In any case, the core control user interface 304 supports receiving user input (e.g., one or more tap inputs or mouse inputs) to request adjustment to active cores 104 of the processor 102 on the fly, e.g., without rebooting. Thus, in accordance with the described techniques, responsive to receipt of user input via the core control user interface 304, the operating system 114 submits a request 124 to the controller 106 indicating to adjust (e.g., activate or deactivate) cores 104, the controller 106 adjusts (e.g., activates or deactivates) one or more of the cores 104 according to the request 124 without rebooting, and the controller 106 issues a communication indicative of the active cores 104 (and a branding configuration) of the processor 102 to the operating system 114 to inform it about the adjustment. In one or more implementations, an adjustment to different active cores 104 (e.g., from a first core configuration to a second core configuration) does not substantially affect interaction of a user with a respective computing device. Because the computing device is not rebooted and because the operating system 114 is informed of the adjustment, for instance, a user is able to continue interacting with the computing device without experiencing significant “downtime,” if any.

Note that in this example 300 all but one of the respective controls 306 include the text ‘Deactivate’ which indicates that all of the respective cores 104 are active at a time the core control user interface 304 is output except for the core 104 corresponding to the core representation 312. Additionally, the mode control 308 with the text ‘Custom’ is visually emphasized relative to the other mode controls 308. This indicates that the ‘Custom’ mode is the “active” mode, e.g., the mode based on which the processor 102 is configured at the time the core control user interface 304 is displayed. In at least one example, the ‘All-Core Mode’ corresponds to operating the processor 102 with all of its cores 104 active. In the context of providing input for voltage droop detection and response overclocking settings, consider the following example.

FIG. 4 depicts a non-limiting example 400 of another user interface in one or more implementations. The example 400 includes a display device 402 outputting a voltage droop setting adjustment user interface 404 that receives user input for adjusting voltage droop settings of the settings 118.

In one or more implementations, the voltage droop setting adjustment user interface 404 includes user interface controls that enable a user to at least one of: adjust voltage droop settings (e.g., of an existing profile), add new voltage droop settings or a new profile, or delete voltage droop settings or an existing profile. In variations, the voltage droop setting adjustment user interface 404 includes user interface controls that enable a user to provide user input to perform different actions in relation to voltage droop settings without departing from the spirit or scope of the described techniques.

In this example 400, the voltage droop setting adjustment user interface 404 includes an adjust existing control 406, an add new control 408, and a delete control 410. The adjust existing control 406 is selectable by a user to adjust existing voltage droop settings, e.g., the voltage droop settings of a profile maintained by the settings 118. The add new control 408 is selectable by a user to add new voltage droop settings and/or a new profile to the settings 118. The delete control 410 is selectable by a user to delete voltage droop settings and/or a profile from the settings 118.

In one or more implementations, as in the illustrated example, the voltage droop setting adjustment user interface 404 includes a profile selection control 412, which enables a user to provide user input to select an existing profile maintained using the settings 118, e.g., to output voltage droop settings associated with a selected profile and/or to adjust voltage droop settings associated with the selected profile. As noted above, the voltage droop settings maintained by the settings 118 and associated with a profile (e.g., a condition such as temperature or a workload) are used to operate in an overclocking mode in one or more implementations.

Here, the voltage droop setting adjustment user interface 404 also includes a profile-specific portion 414. The profile-specific portion 414 is configurable in various ways in different implementations to enable adjustment of voltage droop settings of a profile maintained using the settings 118. In this example 400, for instance, the profile-specific portion 414 displays a profile identifier 416, operating conditions 418 for which the profile is specified to be used, and voltage droop settings 420 associated with the profile, which control overclocking aspects of the processor 102 while operating under the respective operating conditions.

In the example 400, the profile identifier 416 is depicted with an edit control that is selectable by a user to edit the identifier (e.g., a name) of a profile—or to add an identifier to a new profile. The identifier is also storable in or in association with the settings 118 in one or more implementations.

The operating conditions 418 in this example include a temperature range associated with the identified profile, e.g., −190 to −160. As noted above, temperature range is one type of operating condition for which processor overclocking settings (e.g., voltage droop settings) are specifiable in accordance with the described techniques. In addition or alternatively, or instance, a workload or workload group is another type of operating condition for which processor overclocking settings (e.g., voltage droop settings) are specifiable in accordance with the described techniques. The voltage droop setting adjustment user interface 404 includes condition type control 422, which is selectable to specify a type of operating condition that is to be detected in order to use the profile. Examples of different types of conditions include a workload or group of workloads utilizing the system 100, a type of application utilizing the system 100, a stage relative to booting the system 100, and so forth. Certainly, other types of conditions are specifiable via the voltage droop setting adjustment user interface 404 for association with a set of processor overclocking settings (e.g., voltage droop settings) without departing from the spirit or scope of the described techniques. Although a single operating condition is depicted in the illustrated example, it is to be appreciated that the voltage droop setting adjustment user interface 404 and the settings 118 support addition of at least one additional operating condition (e.g., a temperature range and a workload utilizing the processing system) for a given profile, in one or more implementations.

In variations, the voltage droop settings 420 include one or more voltage droop thresholds and one or more corresponding droop responses associated with the identified profile. In this example 400, the identified profile is depicted having two voltage droop thresholds and two corresponding droop responses depicted as frequency adjustments. In particular, the identified profile includes a first voltage droop threshold which the user has configured at 85% of the voltage, and a first droop response which the user has configured at 25 megahertz. The identified profile also includes a second voltage droop threshold which the user has configured at 70% of the voltage, and a second droop response which the user has configured at 60 megahertz. Certainly, only one, or more than two, voltage droop thresholds and droop responses are usable for a profile. With the illustrated voltage droop settings specified, however, the system 100 will decrease the clock rate by 25 megahertz when the voltage droops past the threshold of 85% (e.g., a 15% drop in voltage), and will decrease the clock rate by 60 megahertz when the voltage droops past the threshold of 70% (e.g., a 30% drop in voltage).

As noted above, voltage droop thresholds are specifiable in various ways. In this example, the voltage droop thresholds are depicted as percentages. However, the voltage droop setting adjustment user interface 404 includes controls that are selectable to change a type of threshold. For instance, the controls are selectable to change the type of voltage droop threshold to an offset of a voltage level. Moreover, the specified voltage droop thresholds are displayed with controls that enable those thresholds to be individually adjusted by a user. The voltage droop setting adjustment user interface 404 also includes controls that are selectable to enable voltage droop responses to be individually adjusted by a user.

In this example 400, the profile-specific portion 414 of the voltage droop setting adjustment user interface 404 also includes a more settings control 424, a save control 426, and an activate control 428. In implementations where there are more adjustable processor overclocking settings than voltage droop threshold and droop response, the voltage droop setting adjustment user interface 404 includes user interface controls that enable those settings to be adjusted, e.g., via the more settings control 424. The save control 426 is selectable to save adjustments made to the operating conditions and/or processor overclocking settings (e.g., voltage droop settings) of a profile via the voltage droop setting adjustment user interface 404. Responsive to selection of the save control 426, for example, the settings 118 are updated to maintain the adjusted overclocking settings, e.g., previous settings are replaced by the adjusted settings.

The activate control 428 is selectable by a user to cause the controller 106 to use the processor overclocking settings (e.g., voltage droop settings) of the identified profile and to monitor for the specified operating conditions, e.g., such that the associated settings are used when the operating conditions are detected. For example, the activate control 428 is selectable by a user to cause the controller to use the processor overclocking settings (e.g., voltage droop settings) of an identified profile and to monitor for a workload corresponding to the profile, e.g., such that processor overclocking settings are switched to in real time and without rebooting when the workload is detected.

In one or more implementations, absent selection of the activate control 428, the processor overclocking settings (e.g., voltage droop settings) are maintained in the settings 118 but are not used when the operating condition specified for the profile is detected. After selection of the activate control 428, the processor overclocking settings are used when the operating condition specified for the profile is detected. In a scenario where no operating conditions are specified for a profile, when a user selects the activate control 428, the specified processor overclocking settings are immediately used by the system 100, such that responsive simply to detecting a specified voltage droop, the controller 106 causes the system to implement the corresponding droop response.

It is to be appreciated that the voltage droop setting adjustment user interface 404 is merely one example of a user interface that is usable to adjust processor overclocking settings (e.g., voltage droop settings) of the settings 118. Different user interfaces displaying different user interface controls, and to adjust different processor overclocking settings, are usable to update the settings 118 without departing from the spirit or scope of the described techniques. Although the user interface is depicted being displayed via the display device 402, it is also to be appreciated that the user interface is alternatively or additionally output for interaction with a user in different ways in accordance with the described techniques, such as voice based interface presented via a voice assistant device.

Having discussed example systems and user interfaces for real time workload-based system adjustment, consider the following example procedures.

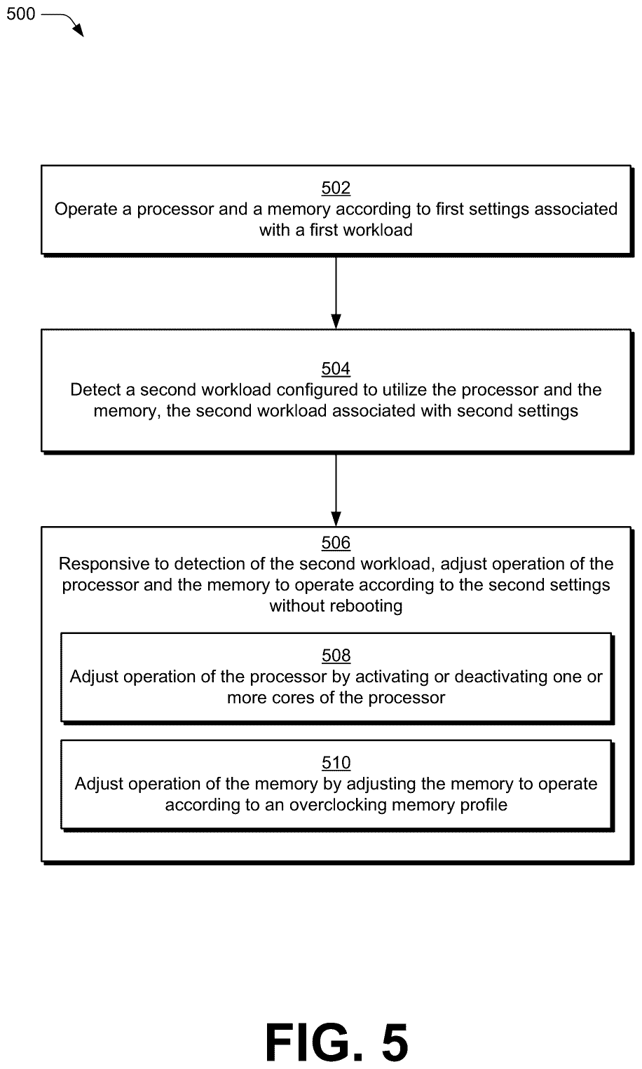

FIG. 5 depicts a procedure in an example 500 implementation of adjusting operation of a processor and a memory without rebooting.

A processor and a memory are operated according to first settings associated with a first workload (block 502). By way of example, processor 102 and memory 108 are operated according to first settings 118 associated with a first workload 122.

A second workload configured to utilize the processor and the memory is detected (block 504). In accordance with the principles discussed herein, the second workload is associated with second settings. By way of example, the controller 106 detects a second workload 122 which is associated with second settings 118. The second settings 118, for example, configure both the processor 102 and the memory 108 differently than the first settings 118.

Responsive to detection of the second workload, operation of the processor and the memory is adjusted to operate according to the second settings without rebooting (block 506). By way of example, responsive to detection of the second workload 122, the controller 106 adjust operation of both the processor 102 and the memory 108 according to the second settings 118 without rebooting.

In example 500, block 506 is depicted as adjusting operation of the processor by activating or deactivating one or more cores of the processor (block 508) and adjusting operation of the memory according to an overclocking memory profile (block 510). By way of example, the controller 106 adjusts operation of the processor 102 by activating or deactivating one or more cores 104 of the processor while also adjusting operation of the memory 108 according to an overclocking memory profile. It is to be appreciated that the controller 106 can adjust operation of the processor 102 and the memory 108 in other ways without departing from the spirit or the scope of the described techniques.

It should be understood that many variations are possible based on the disclosure herein. Although features and controls are described above in particular combinations, each feature or control is usable alone without the other features and controls or in various combinations with or without other features and controls.

The various functional units illustrated in the figures and/or described herein (including, where appropriate, the processor 102 having the multiple cores 104, the controller 106, the memory 108, the clock generator 110, the voltage generator 112, the operating system 114, and the applications 116) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
operating a processor and a memory according to first settings associated with a first workload;
detecting a second workload configured to utilize the processor and the memory, the second workload associated with second settings; and
responsive to the detecting, adjusting operation of the processor and the memory to operate according to the second settings without rebooting.

2. The method of claim 1, further comprising performing the second workload by utilizing the processor or the memory with the adjusted operation.

3. The method of claim 1, wherein the adjusting operation of the processor and the memory comprises activating or deactivating one or more cores of the processor without rebooting.

4. The method of claim 3, further comprising informing an operating system of a number of active cores of the processor.

5. The method of claim 1, wherein the adjusting operation of the processor and the memory comprises adjusting operation of the memory according to an overclocking memory profile without rebooting.

6. The method of claim 5, wherein the overclocking memory profile comprises a high bandwidth overclocking memory profile.

7. The method of claim 5, wherein the overclocking memory profile comprises a low latency overclocking memory profile.

8. The method of claim 1, wherein the adjusting operation of the processor and the memory comprises adjusting the processor to operate in an overclocking mode.

9. The method of claim 1, wherein the adjusting operation of the processor and the memory comprises deactivating one or more cores of the processor and operating the memory according to an overclocking memory profile without rebooting.

10. The method of claim 1, wherein the adjusting operation of the processor and the memory comprises adjusting the processor to operate in an overclocking mode and operating the memory according to an overclocking memory profile without rebooting.

11. A system comprising:
a memory;
a processor having multiple cores; and
a controller configured to adjust operation of the memory and the processor according to different settings without rebooting.

12. The system of claim 11, wherein the controller is configured to adjust operation of the memory and the processor responsive to a workload.

13. The system of claim 11, wherein the controller is configured to adjust operation of the memory and the processor responsive to input from an application.

14. The system of claim 11, wherein the controller is configured to adjust operation of the memory and the processor responsive to user input from a user.

15. The system of claim 11, further comprising a table for storing the different settings, the table accessible by the controller.

16. The system of claim 11, wherein the controller is configured to adjust operation of the memory and the processor by activating or deactivating one or more cores of the processor without rebooting.

17. The system of claim 11, wherein the controller is configured to adjust operation of the memory and the processor by adjusting operation of the memory according to an overclocking memory profile without rebooting.

18. A method comprising:
receiving input to adjust settings for operating a processor and a memory in an overclocking mode, wherein the settings adjusted by the input include at least two of a voltage droop threshold and corresponding response of the processor, a core configuration of the processor, or a clock and power input to the memory; and
responsive to the input, switching operation of the processor and the memory to operate in the overclocking mode without rebooting.

19. The method of claim 18, wherein the input comprises user input received via a user interface.

20. The method of claim 18, wherein the input is received from an application processed by at least one of the memory or the processor.
